(19) United States
(12) Patent Application Publication
(10) Pub. No.: US 2005/0269840 A1
(43) Pub. Date: Dec. 8, 2005

(54) Sealant material

(75) Inventors: Terry Finerman, Rochester Hills, MI (US); Abraham Kassa, Shelby Twp., MI (US)

Correspondence Address: DOBRUSIN & THENNISCH PC, 29 W LAWRENCE ST, SUITE 210, PONTIAC, MI, 48342, US

(73) Assignee: L&L Products, Inc., Romeo, MI (US)

(21) Appl. No.: 11/141,280

(22) Filed: May 31, 2005

Related U.S. Application Data
(60) Provisional application No. 60/577,027, filed on Jun. 4, 2004.

(51) Int. Cl. B62D 25/06

(52) U.S. Cl. 296/210

(57) ABSTRACT

The present invention involves a sealant suitable for sealing substrates of articles of manufacture. In one embodiment, the sealant seals an interface between a first member and a second member. The interface is typically at least partially defined by a gap between the first member and the second member. The sealant is typically activated (e.g., upon exposure to an elevated temperature, to flow and seal the interface. In one preferred embodiment, a plurality of openings are defined in the sealant. Alternatively or additionally, an attachment may be integrated with the sealant such that the attachment can assist in attaching a component of the article of manufacture (e.g., a trim piece of an automotive vehicle) to the sealant.

### FIELD OF THE INVENTION

The present invention relates to a sealant material for sealing a component of an article of manufacture such as an automotive vehicle.

### BACKGROUND OF THE INVENTION

Sealant materials are often applied to a surface for sealing or for otherwise covering the surface, including any joints associated therewith. There presently exist a vast number of sealant materials that serve these purposes for different articles of manufacture.

Formulation of these sealant materials can be difficult since various different and often competing design factors need to be considered. For example, it can be desirable for a sealant material to exhibit desired characteristics such as relatively high levels of adhesion and ease of processing, while, at the same time, it is often desirable for the sealant material to be available at a low cost, which can limit the adhesive capabilities and ease of processing of the material. Thus, there is a need for a sealant material that exhibits desired characteristics while taking into consideration various competing design factors.

Additionally, processing and application of these sealant materials can have negative effects upon the materials. For example, if the sealant materials are heated or become flowable during processing thereof, gas bubbles can become trapped within the materials or bubbles can rise to the surface of the materials thereby forming undesirable surface irregularities. Thus, there is also a need for a sealant material that is less susceptible to negative effects of processing and application of the material.

### SUMMARY OF THE INVENTION

The present invention involves a sealant material suitable for sealing substrates of articles of manufacture. In one embodiment, the sealant seals an interface between a first member and a second member. The interface is typically at least partially defined by a gap between the first member and the second member. The sealant is typically activated (e.g., upon exposure to an elevated temperature, to flow and seal the interface. In one preferred embodiment, a plurality of openings are defined in the sealant. Alternatively or additionally, an attachment may be integrated with the sealant such that the attachment can assist in attaching a component of the article of manufacture (e.g, a trim piece of an automotive vehicle) to the sealant.

### BRIEF DESCRIPTION OF THE DRAWINGS

The features and inventive aspects of the present invention will become more apparent upon reading the following detailed description, claims, and drawings, of which the following is a brief description:

FIG. 1 illustrates a perspective view of an exemplary sealant material formed according to an aspect of the present invention;

FIG. 2 illustrates a perspective view of another exemplary sealant material formed according to an aspect of the present invention;

FIG. 2A illustrates a perspective view of another exemplary sealant material formed according to an aspect of the present invention;

FIG. 2B illustrates a perspective view of another exemplary sealant material formed according to an aspect of the present invention;

FIG. 3 illustrates a sectional view of the exemplary sealant material of FIG. 1 or 2 prior to activation of the material; and

FIG. 4 illustrates a sectional view of the exemplary sealant material of FIG. 1 or 2 after activation of the material.

FIG. 5A-5F illustrate alternative exemplary sealant materials according to the present invention.

FIGS. 6A-6F illustrate additional alternative exemplary sealant materials according to the present invention.

FIGS. 7A-7M illustrate more additional alternative exemplary sealant materials according to the present invention.

FIGS. 8A-8C illustrate an exemplary attachment being applied to a sealant material and an exemplary cover being applied to a structure.

### DETAILED DESCRIPTION OF THE PREFERRED EMBODIMENT

The present invention is predicated upon the provision of an improved sealant material and articles incorporating the same. In one embodiment, the sealant material is formed according to an improved formulation that provides various desirable characteristics to the sealant material. Additionally or alternatively, the sealant material includes one or more openings (e.g. cavities, slits, through-holes, channels, patterns or the like) for aiding the processability of the material.

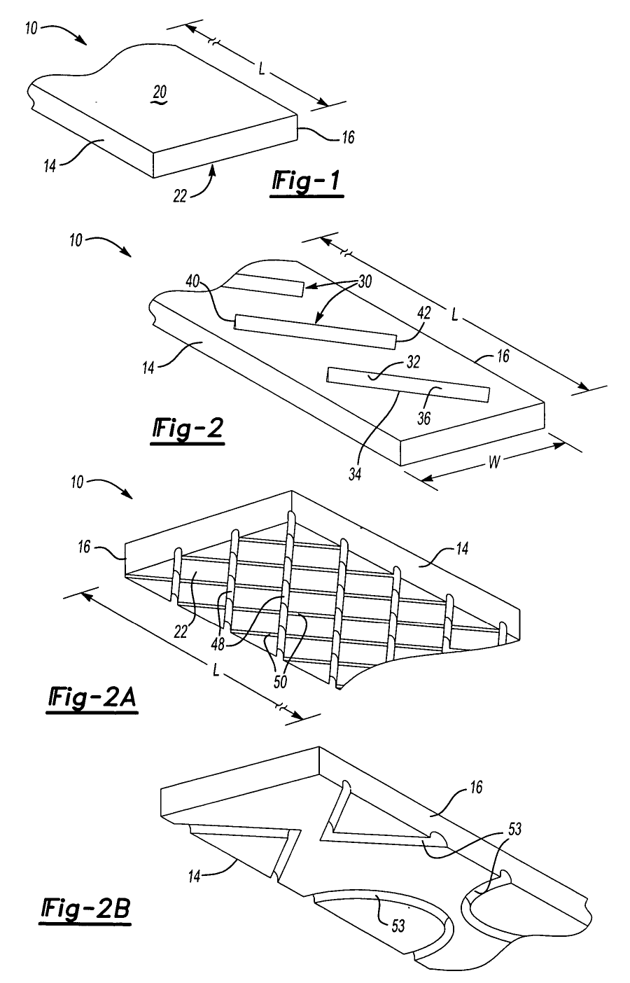

Referring to FIG. 1, there is illustrated one exemplary sealant material 10 formed in accordance with the present invention. It is generally contemplated that, the sealant material may be formed in a variety of shapes or configurations. As shown, the sealant material 10 is shaped as an elongated strip that extends along a length (L) and has a generally rectangular cross-section perpendicular to that length (L). The sealant material 10 is also shown to include a first side 14 opposite a second side 16, both of which extend substantially parallel to the length (L) of the material 10. Futher, the sealant material 10 includes a first surface 20 opposite and substantially parallel to a second surface 22 wherein the first surface 20 is separated from the second surface 22 by a thickness (t). Preferably, the strip of sealant material is formulated according to the formulation further described below. Accordingly, the sealant material of the present invention may be provided as shown in FIG. 1 or according to other shapes and configurations without any additional processing. However, the sealant material may also be further processed to include one or more openings.

As used herein, the term opening is intended to encompass most any type of contour in the sealant material such as, and without limitation, a cavity, a through-hole, a channel, a slit, a pattern, a combination thereof or the like. Moreover it should be understood that such openings may be formed in the sealant material before, during or after the time that the sealant material has been shaped, for example, in the shape shown in FIG. 1.

In FIG. 2 the sealant material 10 of FIG. 1 includes a plurality of openings shown as slits 30. As used herein, a slit is intended to encompass any first surface opposing a second surface wherein the first surface at least opposes and is typically substantially parallel to the second surface and wherein each of the surfaces at least partially extends into a thickness of the sealant material. It is also typical for at least a portion or a substantial portion of the first and second surfaces to be separated by a gap although the surfaces may be partially or fully in abutting contact.

In the embodiment shown in FIG. 2, each of the slits 30 includes a first surface 32 and a second surface 34 at least partially separated by a gap 36. Typically, each slit 30 (i.e., the first surface 32, the second surface 34, the gap 36 or a combination thereof) extends at leat 50%, more typically at least 80% and even more typically at least 95% and still more typicaly 100% of the way through the thickness (t) of the sealant material 10.

Generally, it is contemplated that openings in the sealant material may extend in a variety of different directions and may be configured in a variety of different shapes and may be continuous or intermittent in their extension. In FIG. 2, each of the slits 30 extend from one end 40 adjacent the first side 14 of the strip of sealant material 10 to another end 42 adjacent the second side 16 of the strip of sealant material 10. Also, the slits 30, as they extend from adjacent one side to adjacent the other, may be substantially perpendicular to the length (L) or may be disposed at an angle of between 10° or less and about 80° or greater, more typically between 25° and 65° and even more typically between 30° and 60° (e.g., about 45°±8°) relative to the length (L).

It is also contemplated that the openings in the sealant material may be sized and spaced apart in a variety of different configurations. Moreover, such sizing and spacing may be uniform or non-uniform, unless otherwise stated. The size, shape and length of the slits can vary widely depending upon the size of the sealant material and the intended application of the sealant material. For embodiments in which the slits extend across a width (W) perpendicular to the length (L) (e.g., such as in FIG. 2), the slits typically extend across about 10% to about 98%, more typically about 25% to about 70% and even more typically about 35% to about 60% of the width (W). In one exemplary embodiment, the slits 30 extend between 0.3 cm and about 10 cm, more typically between 1.0 cm and about 4.0 cm and even more typically between about 1.5 cm and about 2.5 cm (e.g., about 2.0 cm) from one end 40 to the other end 42. Also, in typical applications, the slits 30 extend substantially parallel to each other and are uniformly spaced apart a distance between about 0.1 cm and about 8 cm, more typically between about 0.3 cm and about 3 cm and even more typically between about 0.5 cm and about 1.5 cm (e.g., about 0.7 cm).

In FIG. 2A, the sealant material 10 of FIG. 1 includes a plurality of openings shown as channels 48, 50. As can be seen, a set of first channels 48 intersect with a set of second channels 50. Typically each of the first channels 48 intersect with at least one or at least two of the second channels 50. Also, the channels 48, 50 as they extend from one side of the sealant material 10 to the other, may be substantially perpendicular to the length (L) or may be disposed at an angle of between 10° and about 80°, more typically between 25° and 65° and even more typically between about 40° and about 50° (e.g., 45°) relative to the length (L). It is also typical for the first channels 48 to be spaced apart from each other distances that are the same as those recited for the slits 30 of FIG. 2 and the same is true for the second channels 50, although smaller or larger distances are contemplated as well. Typically, the channels extend into the sealant material less than 70%, more typically less than 50% and even more typically less than 30% of the thickness (t) of the sealant material.

In FIG. 2B, the sealant material 10 of FIG. 1 includes a plurality of alternative channels 53 that are V-shaped or U-shaped. As can be sean each of the channels 53 extend to only one of the sides 14, 16, but has at least two outlets at that one of the sides 14, 16.

Generally, the size, shape and configuration of the channels described for FIGS. 2A and 2B can vary. Some exemplary sizes, shapes and configurations are disclosed in WO 2004/037509, which is incorporated herein by reference for all purposes.

The Material

The sealant material can be composed of a variety of different materials. Thus, the preferred materials discussed herein should not be considered limiting unless otherwise stated. Typcially, the sealant material can be activated (e.g., softened, made flowable or both) upon exposure to a stimulus such as heat and/or elevated temperatures. Typically, after activation, the sealant material provides a smooth surface suitable for function such as contacting other components of an article of manufacture (e.g., an automotive vehicle), for being painted, combinations thereof or the like.

When the sealant material is employed for automotive or other applications (e.g., particularly applications where an article is painted, corrosion resistance coated or both), the sealant material or portions thereof are typically activated at an elevated temperature that is experienced during painting, coating (e.g., e-coating) or the like or an article of manufacture such as an automotive vehicle. Thus, the sealant material is typically heated or exposed to a temperature of between about 85° C. and about 325° C., more typically between about 105° C. and about 220° C. even more preferably between about 110° C. and about 180° C. Preferably, although not required, the sealant material is a thermosetting material and activates to cure upon exposure to the elevated temperatures.

Polymeric Materials

The sealant material may include a variety of different polymers. For example, without limitation, polymers that might be appropriately incorporated into the sealant material include halogenated polymers, polycarbonates, polyketones, urethanes, polyesters, silanes, sulfones, allyls, olefins, styrenes, acrylates, methacrylates, epoxies, silicones, phenolics, rubbers, polyphenylene oxides, terphthalates, or mixtures thereof. Other potential polymeric materials may be or may include include, without limitation, polyethylene, polypropylene, polystyrene, polyolefin, polyacrylate, poly(ethylene oxide), poly(ethyleneimine), polyester, polyurethane, polysiloxane, polyether, polyphosphazine, polyamide, polyimide, polyisobutylene, polycaprolactone, polyacrylonitrile, poly(vinyl chloride), poly(methylmethacrylate), poly(vinyl acetate), poly(vinylidene chloride), polytetrafluoroethylene, polyisoprene, ethylene vinyl acetate, polyacrylamide, polyacrylic acid, polymethacrylate, and polyacetals.

One preferred polymer for the sealant material is a copolymer of ethylene methacrylate (EMA). When included, the sealant material typically comprises at least 2% or less, more typically at least 4% and even more typically at least 6% by weight EMA. The sealant material also typically comprises less than 25% or greater, more typically less than 12% and even more typically less than 8% by weight EMA. One particularly preferred acrylate is a relatively high flow ethylene methyl acrylate (EMA) copolymer sold under the tradename OPTEMA TC 140 commercially available from ExxonMobil Chemical.

Another preferred polymer for the sealant material is a copolymer or terpolymer of ethylene modified with glycidyl methacrylate (GMA), maleic anhydride or both, which typically has epoxide functionality. When included, the sealant material typically comprises at least 2% or less, more typically at least 4% and even more typically at least 6% by weight of such copolymer or terpolymer. The sealant material also typically comprises less than 25% or greater, more typically less than 12% and even more typically less than 8% by weight of such copolymer or terpolymer. One particularly preferred terpolymer of ethylene is sold under the tradename LOTADER AX8950 commercially available from Atofina Chemicals.

Epoxy Materials

Epoxy materials can be particularly suitable for the sealant material of the present invention. Epoxy or epoxy resin is used herein to mean any of the conventional dimeric, oligomeric or polymeric epoxy materials containing at least one epoxy functional group. The polymer based materials may be epoxy containing materials having one or more oxirane rings polymerizable by a ring opening reaction. When included, the sealant material typically comprises at least 10% or less, more typically at least 20% and even more typically at least 25% by weight epoxy resin. The sealant material also typically comprises less than 90% or greater, more typically less than 50% and even more typically less than 35% by weight epoxy resin.

The epoxy containing materials may be aliphatic, cycloaliphatic, aromatic or the like. The epoxy may be supplied as a solid (e.g., as pellets, chunks, pieces or the like), a liquid (e.g., an epoxy resin) or both. The epoxy may include an ethylene copolymer or terpolymer that may possess an alpha-olefin. As a copolymer or terpolymer, the polymer is composed of two or three different monomers, i.e., small molecules with high chemical reactivity that are capable of linking up with similar molecules. Preferably, an epoxy resin is added to the sealant material to increase the flow properties of the material. One exemplary epoxy resin may be a phenolic resin, which may be a novalac type or other type resin. Other preferred epoxy containing materials may include a bisphenol-F epoxy resin, a bisphenol-A epichlorohydrin ether polymer, or a bisphenol-A epoxy resin which may be modified with butadiene or another polymeric additive. One exemplary preferred liquid epoxy resin is sold under the tradename ARALDITE EPN 9850 CH and is commercially available from Huntsman Advanced Materials. An exemplary preferred solid epoxy resin is sold under the tradename DER 662 and is commercially available from Dow Chemical Corporation, Midland, Mich. Yet another exemplary preferred epoxy resin is a solid epoxy/rubber adduct sold under the tradename ARALDITE LT-1522ES and is commercially available from Huntsman Advanced Materials.

Curing Agent

One or more curing agents and/or curing agent accelerators may be added to the sealant material. Amounts of curing agents and curing agent accelerators can vary widely within the sealant material depending upon the desired amount of hardness, elasticity or the like of the sealant material, the desired structural properties of the sealant material and the like. Exemplary ranges for the curing agents or curing agent accelerators present in the sealant material range from about 0.1% by weight to about 7% by weight.

Preferably, the curing agents assist the sealant material in curing by crosslinking of the polymers, epoxy resins (e.g., by reacting in stoichiometrically excess amounts of curing agent with the epoxide groups on the resins) or both. It is also preferable for the curing agents to assist in thermosetting the sealant material. Useful classes of curing agents are materials selected from aliphatic or aromatic amines or their respective adducts, amidoamines, polyamides, cycloaliphatic amines (e.g., anhydrides, polycarboxylic polyesters, isocyanates, phenol-based resins (such as phenol or cresol novolak resins, copolymers such as those of phenol terpene, polyvinyl phenol, or bisphenol-A formaldehyde copolymers, bishydroxyphenyl alkanes or the like), or mixtures thereof. Particular preferred curing agents include modified and unmodified polyamines such as triethylenetetramine, diethylenetriamine tetraethylenepentamine, cyanoguanidine and the like. Other useful curing agents include peroxides and peroxide coagents. An accelerator for the curing agents (e.g., methylene diphenyl bis urea) may also be provided for preparing the sealant material.

One exemplary preferred curative is a 4,4′ Methylene bis (phenyl dimethyl urea), sold under the tradename OMICURE U52M commercially available from CVC Specialty Chemicals. Another exemplary preferred curative is a dicyandiamide sold under the tradename AMICURE CG325 and is commercially available from Air Products.

Filler

The sealant material may also include one or more fillers, including but not limited to particulated materials (e.g., powder), beads, microspheres, or the like. Preferably the filled includes a relatively low-density material that is generally non-reactive with the other components present in the sealant material.

Examples of fillers include silica, diatomaceous earth, glass, clay, talc, pigments, colorants, glass beads or bubbles, glass, carbon ceramic fibers, antioxidants, and the like. Such fillers, particularly clays, can assist the sealant material in leveling itself during flow of the material. The clays that may be used as fillers may include clays from the kaolinite, illite, chloritem, smecitite or sepiolite groups. Examples of suitable fillers include, without limitation, talc, vermiculite, pyrophyllite, sauconite, saponite, nontronite, montmorillonite or mixtures thereof. The clays may also include minor amounts of other ingredients such as carbonates, feldspars, micas and quartz. The fillers may also include ammonium chlorides such as dimethyl ammonium chloride and dimethyl benzyl ammonium chloride. Titanium dioxide might also be employed. A clay or mineral filler that can provide desirable rheological characteristic and includes a blend of organically modified minerals is sold under the tradename GARAMITE commercially available from Southern Clay Products.

In one preferred embodiment, one or more mineral or stone type fillers such as calcium carbonate, sodium carbonate or the like may be used as fillers. In another preferred embodiment, silicate minerals such as mica may be used as fillers. It has been found that, in addition to performing the normal functions of a filler, silicate minerals and mica in particular can assist in providing desirable rheological characteristics (e.g., desired flow characteristics). One preferred mineral type filler is a natural calcium silicate have a fibrous type structure also referred to as wollastonite.

When employed, the fillers in the sealant material can range from 10% to 90% by weight of the sealant material. According to typical embodiments the sealant material comprises at least 20% or less, more typically at least 30% and even more typically at least 45% by weight filler. The sealant material also typically comprises less than 80% or greater, more typically less than 70% and even more typically less than 65% by weight filler.

Other Additives

Other additives, agents or performance modifiers may also be included in the sealant material as desired, including but not limited to a UV resistant agent, a flame retardant, an impact modifier, a heat stabilizer, a colorant or pigment (e.g., carbon black), a processing aid, a lubricant, a reinforcement (e.g., chopped or continuous glass, ceramic, aramid, or carbon fiber or the like), an epoxy/elastomer adduct, an alkyl phthalate (e.g., di normal alkyl phthalate or di-n-undecyl phthalate), an ester (e.g., 1,2 benzenedicarboxylic acid, diundecyl ester), a plasticizer, a rheology modifier. It is also contemplated that, if a cellular structure is desired, the sealant material may include a blowing agent, a blowing agent accelerator or both. One exemplary preferred rheology modifier is a butyl acrylate.

### EXAMPLES

For illustrative purposes, table A has been provided to show an exemplary formulation for the sealant material.

1/32 TABLE A

| Ingredients | Weight Percentages |
|---|---|
| Solid Epoxy Resin | 19.75% |
| Liquid Epoxy Resin | 9.9% |
| EMA | 7.4% |
| Ethylene copolymer or terpolymer | 7.4% |
| Calcium carbonate (filler) | 49.55% |
| Epoxy curatives | 0.95% |
| Carbon Black | 0.05% |

Exemplary alternative formulations for the sealant material are disclosed in WO 2004/037509, which is incorporated herein by reference for all purposes.

Formation

The sealant material of the present invention may be formed using several different techniques. Preferably, the sealant material has a substantially homogeneous composition within itself, however, it is contemplated that various combining techniques may be used to increase or decrease the concentration of certain components in certain locations of the portions of the sealant material or the sealant material itself.

According to one embodiment, the sealant material can be formed by supplying the components of the material in solid form such as pellets, chunks and the like, in liquid form or a combination thereof. The components are typically combined in one or more containers such as large bins or other containers. Preferably, the containers can be used to intermix the components by rotating or otherwise moving the container or by moving the components within the container. If needed or desired, heat, pressure or a combination thereof may be applied to soften or liquidize the components such that the components can be more easily intermixed into a single homogenous composition.

Generally, the sealant material can be shaped using a variety of techniques. For example, the sealant material can be molded (e.g, compression molded, injection molded, calandering, combinations thereof or the like). As another example, the sealant material may be extruded as a strip having a desired cross-sectional configuration. Various extruders such as a single screw extruder or a twin screw extruder may be employed to extrude the sealant material.

As shown, the sealant material 10 is extruded as a strip having a rectangular or square cross-section, however, other section shapes (e.g., having an asymmetrical shape about a longitudinal axis, a symmetrical shape about the longitudinal axis, varying shapes along the longitudinal axis, longitudinal channels or passages, or the like) are contemplated as well and may be formed as desired or needed for any chosen application. In one embodiment, it is contemplated that the sealant material may be placed upon a patterned conveyor belt after formation (e.g., after extrusion) for forming openings such as the channels 48, 50 in the sealant material of FIG. 2A.

The slits 30 or other openings (e.g., channels) of the sealant material may be formed in the sealant material 10 using a variety of techniques. For example, a press die with multiple protrusions can be used to press the openings into the sealant material and may optionally, at the same time, cut out the desired shape of the sealant material. As another example, a roll die with multiple protrusions can be use to press the openings into the sealant material and again, may optionally, simultaneously cut out the desired shape of the sealant material.

Upon formation, the sealant material can be relatively flexible for allowing an individual to align the part along a substrate in a desired shape or configuration. Alternatively, the sealant material can be more rigid and can be formed in a desired shape or configuration corresponding to a substrate to which the material will be applied.

Application

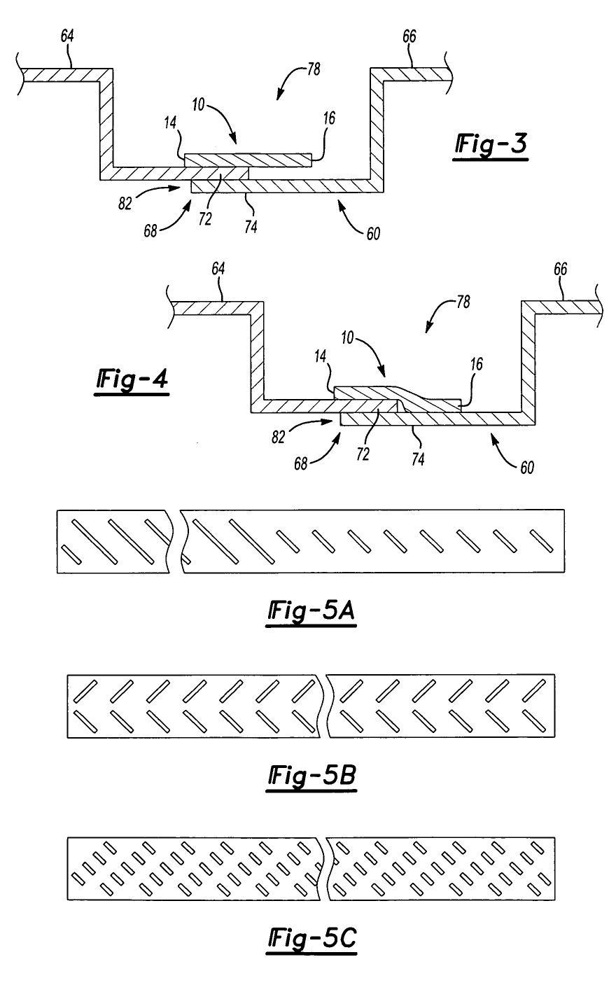

FIGS. 3-4 illustrate an example of the sealant material 10 of the present invention being applied to a substrate 60. The sealant material 10, which may be configured as shown in FIGS. 1-2A or otherwise configured, may be applied to a variety of substrates. However, for exemplary purposes and with no intention of limiting the invention, the material 10 is shown as applied to components 64, 68 (e.g., overlapping panels) for forming a joint 68. The joint 68, as shown, is formed with overlapping ends 72, 74 of the two components 64, 68. In one embodiment, the substrate is formed of a material that includes metal (e.g., steel, aluminum, iron, tin, magnesium, a combination thereof or the like), plastic (e.g., reinforced plastic), a combination thereof or the like.

As discussed, the sealant material 10 may be formed in a variety of shapes, sizes, patterns, thicknesses or the like and may be formed using a variety of forming techniques such as molding, extruding, thermosetting and the like. It is also contemplated that the sealant material or one of the portions thereof may be initially formed in a substantially liquid state wherein the material is shaped by its container or shaped by a substrate to which the material has been applied.

The sealant material may be dry to the touch shortly after it is initially formed to allow easier handling, packaging and the like of the material, however, it is also possible for the material to be wet, tacky or both. As such, the sealant material may be placed adjacent a substrate either manually, automatically or semi-automatically. In one preferred embodiment, the sealant material is extruded directly onto the substrate that is to be sealed by the material or extruded and then placed on the substrate. In another embodiment, an individual can manually place the sealant material on the substrate.

In the embodiment illustrated in FIG. 3, the sealant material 10 is placed within an opening 78 (e.g., a cavity, ditch or recess) that is formed by the panels 64, 66. In the particular embodiment illustrated, the opening 78 is a roof ditch of an automotive vehicle that is typically formed from body panels of the vehicle. As shown, the overlapping ends 72, 74 of the panels 64, 66 at least partially define the opening 78 and the overlapping ends 72, 74 form an interface 82 between the two panels 64, 66. Typically, the interface 82 will define one or more gaps between the overlapping ends 72, 74 of the panels 64, 66, even though effort is typically expended to minimize such gaps for articles of manufacture such as automotive vehicles.

For sealing a substrate, the sealant material is typically placed upon the substrate such that it overlays the joint 68, the gap, the interface 82 or a combination thereof. It should be understoond, however, that the sealant material 10 may be placed over or adjacent any type of opening of a substrate such as a cavity, a recess, a gap or the like or may be placed over or adjacent a flat or contoured portion of the substrate for sealing that opening or portion.

Once the sealant material has been formed in a desired configuration and located, as desired, relative to a substrate, the material may be activated (e.g. made flowable and cured) to form a seal of a desired configuration. Activation of the sealant material may take place in a single stage or multiple stages and may utilize a variety of stimuli to cause the activation. Activation, as used herein, generally denotes inducing the sealant material 10 to flow, generally soften, possibly foam and expand, cure or a combination thereof and can be caused by exposure of the sealant material to a variety of stimuli such as heat, light, electricity, pressure, moisture and the like. Curing, as used herein, generally denotes any stiffening, hardening, solidifying or the like of the sealant material and can be caused by exposure to a variety of stimuli such as heat, cooling, light, moisture combinations thereof or the like.

According to another embodiment, the sealant material may undergo a single stage activation (e.g., cure). According to still other embodiments, the sealant material may undergo a selective multiple stage activation (e.g. cure). For example, a portion of the sealant material may be exposed to a stimulus to at least partially cure a portion of the sealant material, e.g. a cure to a predetermined depth (e.g., on the order of about 1 mil to about 2 mm), or a cure in certain regions along or within the mass of material.

In the particular embodiment illustrated in FIG. 3, the sealant material 10 is activated by exposure to heat or elevated temperature (e.g., provided as part of a corrosion coating or painting operation of an automotive vehicle). As can be seen in FIG. 4, the sealant material flows and cures to adhere itself to the substrate thereby sealing the joint 68, the gap, the interface 82 or a combination thereof.

Additionally or alternatively, it is contemplated that a sealed joint prepared in accordance with the present invention can be further coated with a top coat (e.g., a paint) and optionally a primer (between the top coat and the joint), a clear coat (e.g., a polyurethane, an acrylic such as a glycidyl methacrylate (GMA)-based coating, or a mixture thereof) over the top coat, or a combination thereof. Preferably one such coating is a water-based coated, although solvent based coatings may also be used. In one embodiment, the coating includes a two component polyurethane coating. In another embodiment the coating is applied as a powder coating. Preferably an electocoating process is used to apply a coating layer, such as the primer.

Advantageously, the openings of the sealant material 10 in FIGS. 2 and 2A can assist in allowing air or other gasses to escape from between the substrate and sealant material during activation. In particular, the slits 30 of FIG. 2 can allow gas to escape through the slits 30 and upon further flow, the slits 30 typically close and the surfaces 32, 34 of the slits 30 seal together such that the sealant material can effectively perform its sealing function. In FIG. 2A, gas can escape through the channels 48, 50 and be purged at the sides 14, 16 of the sealant material 10 particularly when the channels face the substrate to which the material is applied.

In preferred alternative embodiments, it is contemplated that the openings (e.g., slits) can have a variety of configurations. For example, the slits or channel may be patterned as a logo, or in a decorative configuration. As another example, the slits or channels could be written as words that convey information (e.g., installation or assembly information).

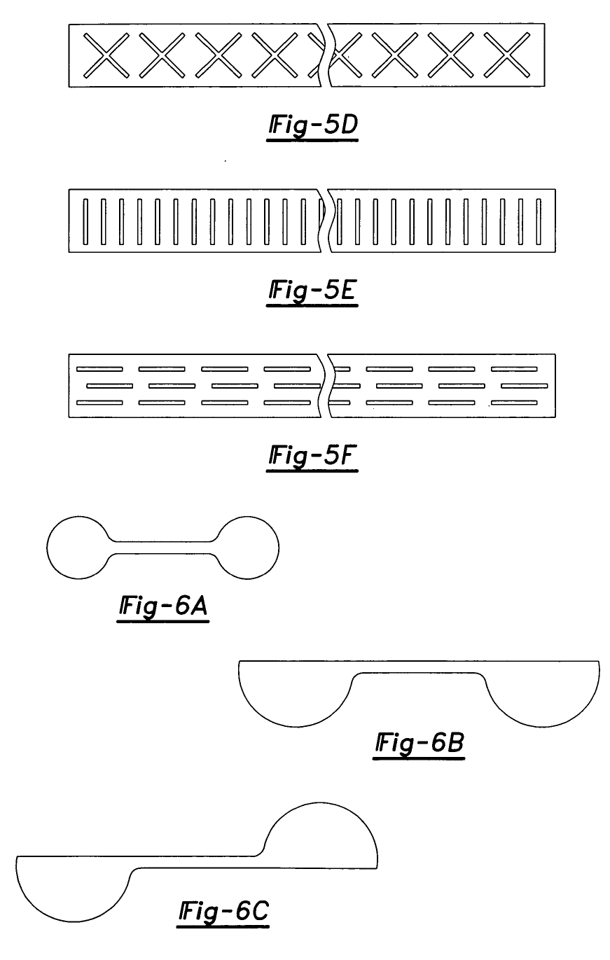

FIGS. 5A-5F illustrate sealant materials with alternative slits. In FIG. 5A, the slits vary in the distance that they extend across the width of the sealant material. In FIG. 5B, the slits are in pairs along the length of the sealant material, the slits of each pair being disposed at angles relative to the length of the sealant material, the slits of each pair being skew to each other. In FIG. 5C, multiple small parallel slits extend in groups across the width of the sealant material, the groups being disposed at an angle relative to the length of the sealant as they extend across the width. In FIG. 5D, the slits are in intersecting pairs that form an X shape as they extend across the width of the sealant material. In FIG. 5E, multiple slits are perpendicular to the length of the sealant material. In FIG. 5F, groups of slits extends parallel to each other along the length of the sealant material.

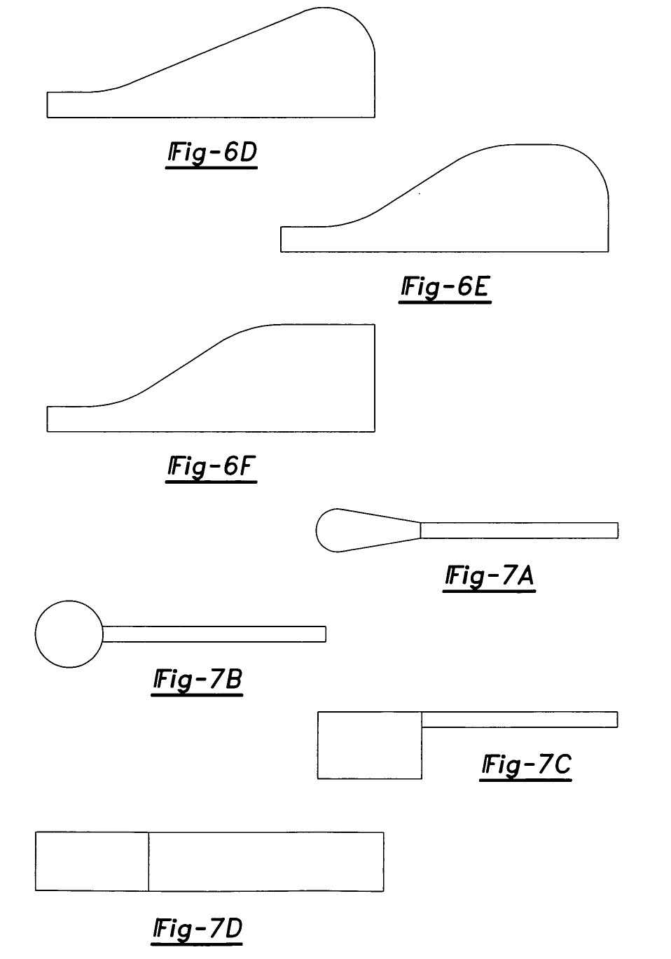

FIGS. 6A-6F illustrate multiple different possible alternative cross-sections of the sealant material. In FIGS. 6A-6C, the cross-sections of the sealant materials include larger or thicker portions at opposite sides of the material and a smaller or thinner portion therebetween interconnecting the larger portions. In FIGS. 6D-6F, the cross-section of the sealant material include a larger or thicker portion at one side of the material and a smaller or thinner portion at another side of the material.

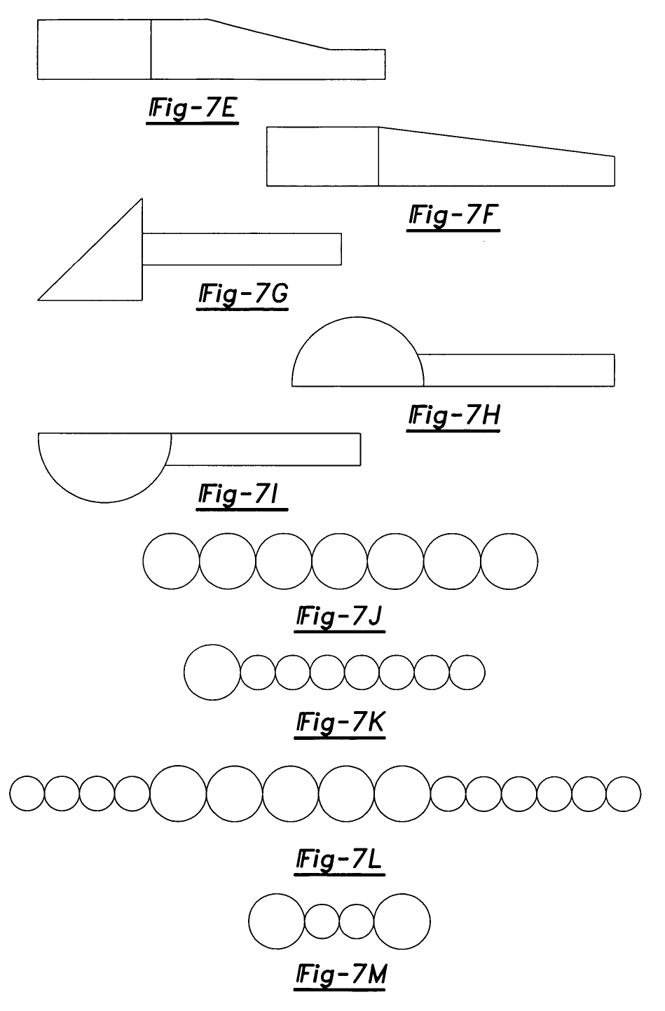

FIGS. 7A-7M illustrate multiple different possible alternative cross-section of the sealant material that have multiple portions that are typically connected to each other and typically have compositions that are different than each other. A discussion of such portion is disclosed in commonly owned copending U.S. Provisional patent application Ser. No. 60/558,594, also titled “Sealant Material” and incorporated herein by reference for all purposes.

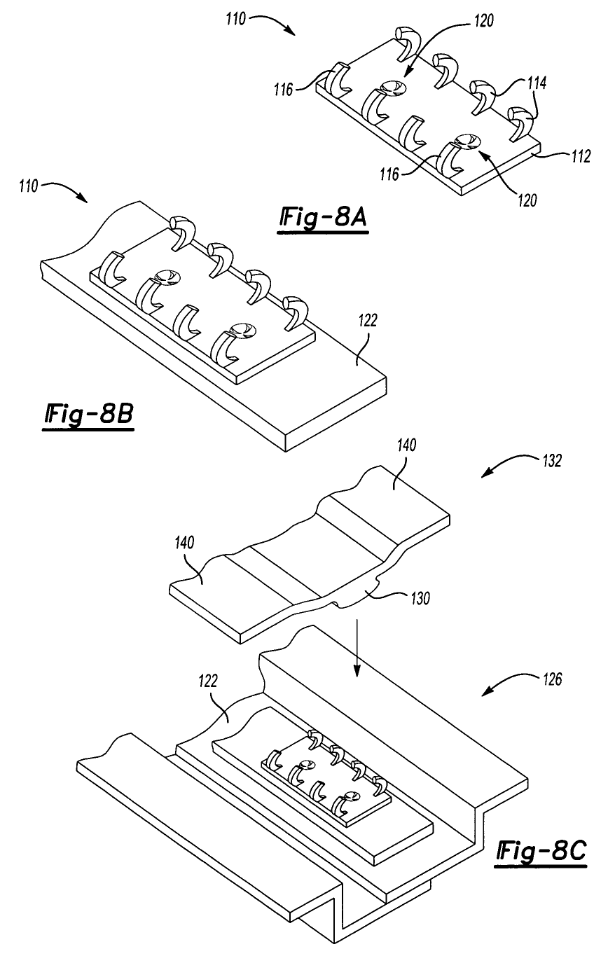

As another addition or alternative to the sealant material described above, it is contemplated that an attachment may be integrated with the sealant material of the present invention. Advantageously, the attachment of the present invention can assist the sealant material in attaching to components of an article of manufacture in addition to the substrate, which the sealant material is sealing. While the sealant material shown in FIGS. 8(b)-8(c) is illustrated as being a single continuous strip, it is contemplated that the attachment of the present invention may be employed in conjunction with any of the sealant materials disclosed herein and may be employed in conjunction with other materials as well.

Generally, an attachment according to the present invention will have one or more members for assisting the attachment in attaching to the sealant material. As an example, the attachment may include one or more protrusions designed to extend into the thickness of the sealant material. The attachment will also typically include one or more members for assisting the sealant material in attaching to another component of the article of manufacture. As an example, the attachment could include one or more extensions designed to be interference fit to a component (e.g., a cover) of an article of manufacture.

Referring to FIG. 8(a), one exemplary attachment 110 according to the present invention. The attachment 110 includes a base portion 112 and multiple extensions 114, 116 extending from the base portion 111. In the depicted embodiment, a set of first extensions 114 extend from a first side of the base portion 112 and a second set of extensions 116 extend from the second side of the base portion 112. As shown, the second side of the base portion 112 is generally opposite the first side of the base portion. Also as shown, the first extensions 114 and second extensions 116 extend outwardly away from each other and then back toward each other such that the first extensions 114 substantially oppose the second extensions 116.

The attachment 110 also includes members for assisting in attaching the attachment 110 to a sealant material. In the embodiment shown, rosebud shapes protrusions 120 are formed in the base portion 112 for assisting in integrating the attachment 110 with the sealant material. In FIG. 8(b), the protrusions 120 have been extended into a thickness of a sealant material 122 for attaching the attachment to the sealant material 122.

In FIG. 8(c), the sealant material 122 has been applied to a substrate, which is illustrated to be panels forming a roof ditch 126 as previously discussed in greater detail. Once the sealant material 112 has been applied and preferably, although not required, activated to seal the substrate, a component (e.g., a cover) of an article of manufacture can be connected to the sealant material 122 by attaching the component to the attachment 110. In the illustrated embodiment, a central portion 130 of a trim piece 132 is interference fit between the first and second extensions 114, 116 of the attachment 110 for attaching the trim piece 132 to the attachment 110, the sealant material 122, the substrate (e.g., roof ditch structure 126) or any combination thereof. The particular trim piece 132 illustrated includes panel portions 140 extending outwardly from the central portion 130 for, upon attachment, assisting in covering a larger area of the substrate.

Unless stated otherwise, dimensions and geometries of the various structures depicted herein are not intended to be restrictive of the invention, and other dimensions or geometries are possible. Plural structural components can be provided by a single integrated structure. Alternatively, a single integrated structure might be divided into separate plural components. In addition, while a feature of the present invention may have been described in the context of only one of the illustrated embodiments, such feature may be combined with one or more other features of other embodiments, for any given application. It will also be appreciated from the above that the fabrication of the unique structures herein and the operation thereof also constitute methods in accordance with the present invention.

The preferred embodiment of the present invention has been disclosed. A person of ordinary skill in the art would realize however, that certain modifications would come within the teachings of this invention. Therefore, the following claims should be studied to determine the true scope and content of the invention.

1. A substrate of an article of manufacture; comprising:
a first member;
a second member adjoining said first member and forming an interface therebetween, the interface at least partially defined by a gap between the first member and the second member;
a sealant over the first member, the second member, the interface or a combination thereof, wherein:
i) upon exposure to an elevated temperature, the sealant flows to seal the interface.

2. A substrate as in claim 1 wherein the elevated temperature is a temperature typically experienced in an e-coat or paint oven during assembly of an automotive vehicle.

3. A substrate as in claim 1 wherein the sealant material has a plurality of openings.

4. A substrate as in claim 3 wherein the plurality of openings are slits that extend through the sealant material from adjacent one surface to adjacent a second surface.

5. A substrate as in claim 4 wherein the plurality of slits are substantially parallel to each other.

6. A substrate as in claim 5 wherein each slit of the plurality of slits extends substantially entirely through a thickness of the strip.

7. A substrate as in claim 3 wherein the plurality of openings are cavities in a surface of the sealant material that extend to a side of the sealant material.

8. A substrate as in claim 1 wherein an attachment is integrated with the sealant material.

9. A substrate as in claim 1 wherein the attachment attaches a cover to the sealant material.

10. A substrate as in claim 9 wherein the cover is a trim piece for the article of manufacture.

11. A substrate as in claim 10 wherein the attachment includes protrusions that extend into the sealant for attaching the attachment to the sealant.

12. A substrate as in claim 11 wherein the attachment includes a base portion and multiples extensions that are interference fit to at least a portion of the cover.

13. A substrate as in claim 12 wherein the article of manufacture is an automotive vehicle and the first member and the second member are components of the automotive vehicle.

14. A substrate as in claim 13 wherein the first member and second member define a roof ditch of the automotive vehicle.

15. A substrate of an automotive vehicle, comprising:
a first panel;
a second panel adjoining said first panel and forming an interface therebetween, the interface at least partially defined by a gap between the first member and the second member;
a sealant over at least partially over the interface or a combination thereof, wherein:
i) the sealant includes a plurality of slits extending substantially through a thickness of the sealant;
ii) upon exposure to an elevated temperature encountered in an e-coat or paint oven, the sealant material is activated to flow and adhere to the first panel and the second panel to seal the interface.

16. A substrate as in claim 15 wherein the slits that extend through the sealant material from a first surface of the sealant to a second surface of the sealant and, upon further flow of the sealant, surfaces defining the slits seal together for assisting the sealant in sealing the interface.

17. A substrate as in claim 16 wherein the plurality of slits are substantially parallel to each other.

18. A substrate as in claim 15 wherein an attachment is integrated with the sealant material.

19. A substrate of an automotive vehicle, comprising:
a first panel;
a second panel adjoining said first panel forming an interface therebetween, the interface at least partially defined by a gap between the first panel and the second panel;
a sealant over the first panel, the second panel and the interface, the sealant material having a plurality of slits extending therethrough, wherein:
i) the sealant material is provided as a strip having a length, a first side and a second side extending along the length and a first surface and second surface separated by a thickness;
ii) the plurality of slits extend from adjacent the first side to adjacent the second side;
iii) the plurality of slits are substantially parallel to each other; and
iv) each slit of the plurality of slits extends substantially entirely (i.e. at least 70%) through the thickness of the strip; and
v) each slit of the plurality of slits is defined by a first surface and a second surface of the strip, the first surface being substantially opposing and parallel to the second surface.

20. A substrate as in claim 19 wherein the first panel and second panel form a roof ditch of a roof of an automotive vehicle.
